(19) United States
(12) Patent Application Publication
(10) Pub. No.: US 2024/0198560 A1
(43) Pub. Date: Jun. 20, 2024

(54) MODIFICATION OF DIGITAL PORES IN SCREEN DIGITAL MODELS

(71) Applicant: Hewlett-Packard Development Company, L.P., Spring, TX (US)

(72) Inventors: John Joseph BRIDEN, Palo Alto, CA (US); Matthew Allen SHEPHERD, Vancouver, WA (US)

(21) Appl. No.: 18/286,120

(22) PCT Filed: Apr. 13, 2021
(86) PCT No.: PCT/US2021/027110

§ 371 Date: Oct. 7, 2023

(51) Int. Cl. B29C 33/38

(52) U.S. Cl. CPC B29C 33/3835

(57) ABSTRACT

According to examples, computer-readable instructions may cause a processor to obtain a digital model of a screen to be fabricated by a 3D fabrication system, the digital model of the screen including digital pores. The processor may obtain a digital model of a mold body on which the screen is to be removably mounted, the digital model of the mold body including a plurality of digital holes. In addition, the processor may, for a digital pore, determine a distance between the digital pore and a digital hole when the digital model of the screen is positioned on the digital model of the mold body. The processor may further determine whether the determined distance falls below a first threshold and based on a determination that the determined distance falls below the first threshold, cause a parameter of the digital pore to be modified in a first manner.

### BACKGROUND

Various types of products may be fabricated from a pulp of material. Particularly, a pulp molding die that includes a main body and a wire mesh may be immersed in the pulp of material and the material in the pulp may form into the shape of the main body and the wire mesh. The main body and the wire mesh may have a desired shape of the product to be formed and may thus have a complex shape in some instances. The main body and the wire mesh may include numerous pores for liquid passage, in which the pores in the wire mesh may be significantly smaller than the pores in the main body. During formation of the product, a vacuum force may be applied through the pulp molding die which may cause the material in the pulp to be sucked onto the wire mesh and form into a shape that matches the shape of the pulp molding die. The material may be removed from the wire mesh and may be solidified to have the desired shape.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example computer-readable medium that may have stored thereon computer-readable instructions for causing a parameter of a digital pore in a digital model of a screen having a plurality of pores to be modified to reduce or prevent a pulp part from being damaged while being suctioned onto the screen or while being blown off the screen;

FIG. 2A shows a diagram of an apparatus, which may include an example processor that may execute the computer-readable instructions stored on the example computer-readable medium;

FIGS. 2B and 2C, respectively, show enlarged view examples of a section of a screen digital model and a main body digital model;

FIGS. 3A and 3B, respectively, depict, cross-sectional side views of an example forming tool and an example transfer tool; and

FIGS. 4 and 5 respectively show flow diagrams of example methods for causing a size and/or a shape of a digital pore to be modified based on a distance between the digital pore and a digital hole in a mold body digital model.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Disclosed herein are apparatuses, methods, and computer-readable media, in which a processor may determine distances between digital pores in a digital model of a screen and digital holes in a digital model of a mold body. The processor may determine whether the determined distance falls below a first threshold and, based on a determination that the determined distance falls below the first threshold, cause a parameter of the digital pore to be modified in a first manner. The parameter of the digital pore may be a size and/or a shape of the digital pore. Various manners in which the parameter of the digital pore may be modified are discussed herein.

In instances in which the pores in a screen have common parameters, flow rates of liquid and/or air through the pores may differ with respect to each other due to differences in the positions of the pores in the screen with respect to the holes in the mold body. That is, the pores that are positioned in closer proximities to the holes may experience greater levels of flow than the pores that are positioned farther away from the holes. In some instances, the differences may result in pressure differences that may be sufficiently large to potentially cause a wet part being formed on the screen to become damaged. Through implementation of the features of the present disclosure, some of the pores may be modified, for instance, to reduce the flow rate through the pores. The reduction in flow rate may reduce or prevent the large pressure difference across the pores, which may reduce or prevent a wet part from being damaged while pressure is applied on the wet part through the pores.

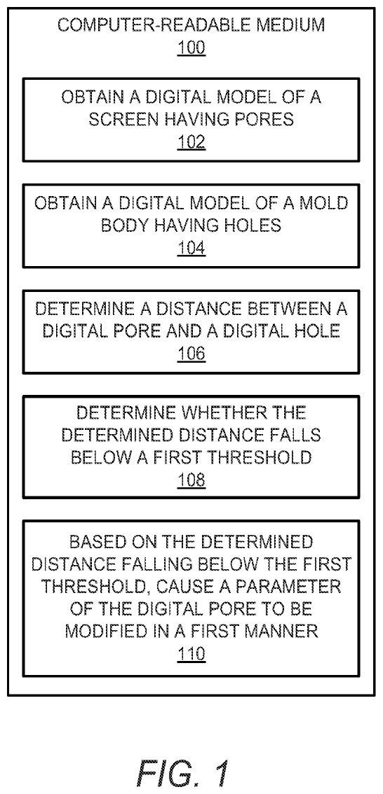

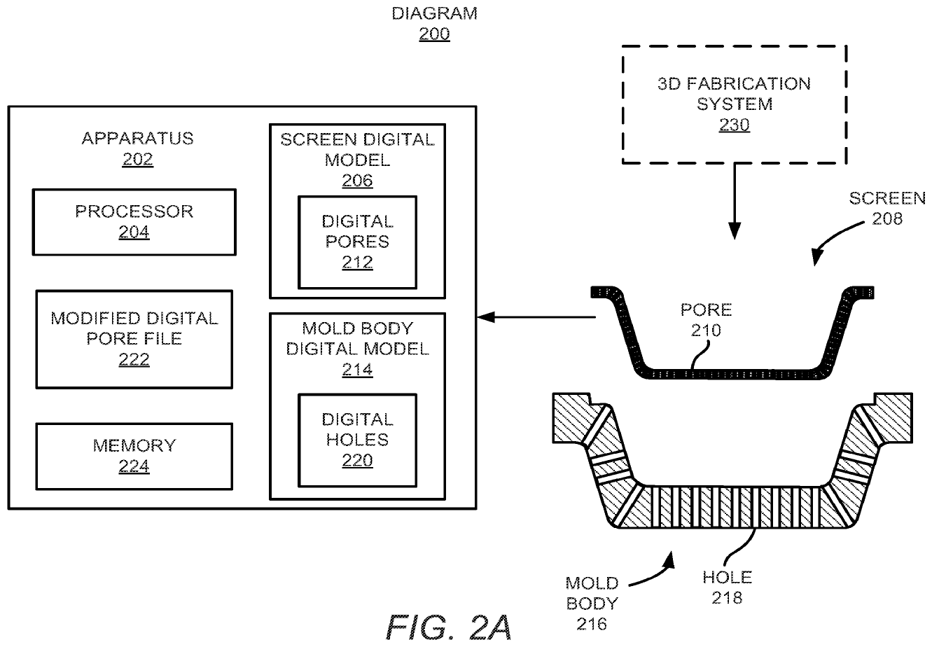

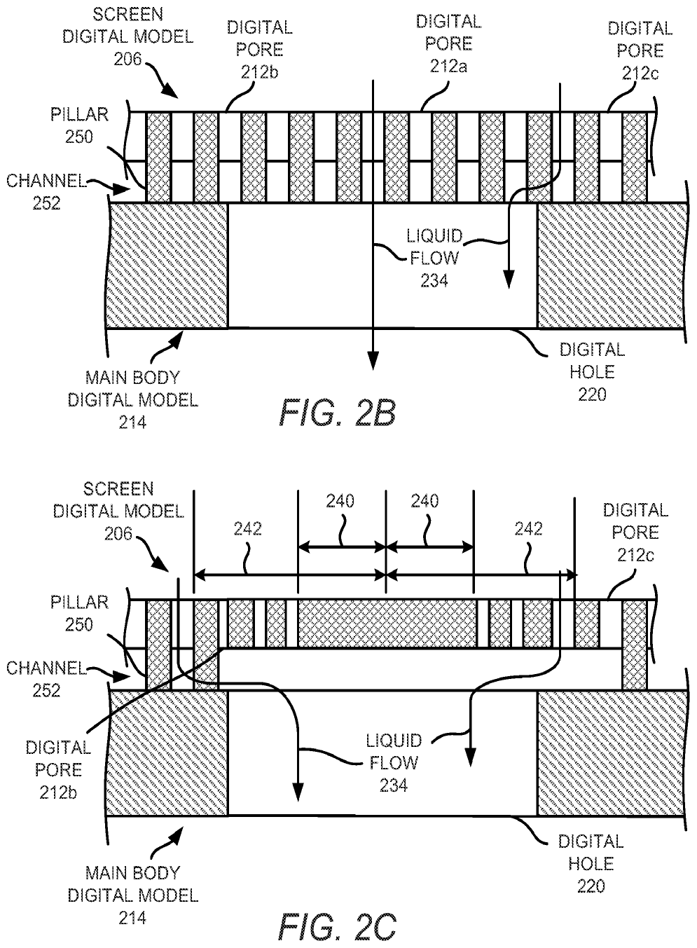

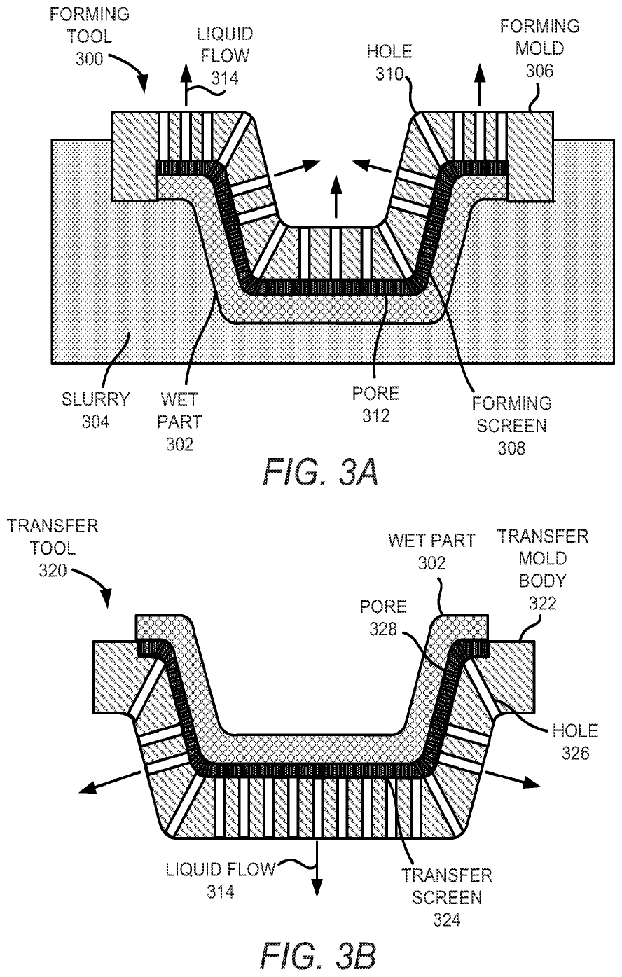

Reference is first made to FIGS. 1, 2A-2C, 3A, and 3B. FIG. 1 shows a block diagram of an example computer-readable medium 100 that may have stored thereon computer-readable instructions for causing a parameter of a digital pore in a digital model of a screen having a plurality of pores to be modified to reduce or prevent a pulp part from being damaged while being suctioned onto the screen or while being blown off the screen. FIG. 2A shows a diagram 200 of an apparatus 202, which may include an example processor 204 that may execute the computer-readable instructions stored on the example computer-readable medium 100. FIGS. 2B and 2C, respectively, show enlarged view examples of a section of a screen digital model and a main body digital model. FIGS. 3A and 3B, respectively, depict, cross-sectional side views of an example forming tool 300 and an example transfer tool 320.

It should be understood that the example computer-readable medium 100 depicted in FIG. 1, the example apparatus 202 depicted in FIG. 2A, the screen digital model 206 and the main body digital model 214 depicted in FIGS. 2B and 2C, and/or the example forming tool 300 and the example transfer tool 320 respectively depicted in FIGS. 3A and 3B may include additional attributes and that some of the attributes described herein may be removed and/or modified without departing from the scopes of FIGS. 1-3B.

The computer-readable medium 100 may have stored thereon computer-readable instructions 102-110 that a processor, such as the processor 204 depicted in FIG. 2A, may execute. The computer-readable medium 100 may be an electronic, magnetic, optical, or other physical storage device that contains or stores executable instructions. The computer-readable medium 100 may be, for example, Random Access memory (RAM), an Electrically Erasable Programmable Read-Only Memory (EEPROM), a storage device, an optical disc, and the like. Generally speaking, the computer-readable medium 100 may be a non-transitory computer-readable medium, in which the term “non-transitory” does not encompass transitory propagating signals.

The processor 204 may fetch, decode, and execute the instructions 102 to obtain a digital model 206 of a screen 208 to be fabricated by a three-dimensional (3D) fabrication system 230. As shown in FIG. 2A, the screen 208 may include a plurality of pores 210 and the digital model 206 of the screen 208, which is also referenced herein as a screen digital model 206, may include digital pores 212 corresponding to the plurality of pores 210. As discussed herein, the screen 208 may be implemented in a formation of a wet part 302 from a slurry 304 of a liquid and material elements as discussed herein. In some examples, the screen 208 may be a forming screen 308 of a forming tool 300 as shown in FIG. 3A, in which case the screen digital model 206 may be a digital model of a forming screen 308. In addition or in other examples, the screen 208 may be a transfer screen 324 of a transfer tool 320, in which case the screen digital model 206 may be a digital model of a transfer screen 324. In some examples, the digital pores 212 may be positioned through application of a packing algorithm, which may maximize the number of digital pores 212 across the screen digital model 206. The forming tool 300 and the transfer tool 320 are described in greater detail herein.

The processor 204 may fetch, decode, and execute the instructions 104 to obtain a digital model 214 of a mold body 216. The digital model 214 of the mold body 216 is also referenced herein as a mold body digital model 214. As also shown in FIG. 2, the mold body 216 may include a plurality of holes 218 and the mold body digital model 214 may include digital holes 220 corresponding to the plurality of holes 218. As discussed herein, the mold body 216 may also be fabricated by the 3D fabrication system 230 and may form part of either or both of the forming tool 300 and the transfer tool 320. That is, the mold body 216 may be positioned beneath the screen 208 and may provide support for the screen 208.

According to examples, and as discussed in greater detail herein, the forming tool 300 and the transfer tool 320 may be employed in the fabrication of a wet part 302 from a slurry 304 of a liquid and material elements. In some examples, the liquid may be water or another type of suitable liquid in which pulp material, e.g., paper, wood, fiber crops, bamboo, or the like, may be mixed into the slurry 304. The material elements may be, for instance, fibers of the pulp material. The wet part 302 may thus be formed of molded fiber.

The digital models 206 and 214 may each be a respective 3D computer model of a respective one of the screen 208 and the mold body 216, such as a computer aided design (CAD) file, or other digital representation of these components. That is, for instance, the digital models 206 and 214 may be computer files that a processor or controller of the 3D fabrication system 230 may use to fabricate the pore 210 and the mold body 216, respectively. In any regard, the processor 204 may obtain (or equivalently, access, receive, or the like) the digital models 206, 214 from a data store (not shown) or some other suitable source. In some examples, the digital models 206, 214 may be generated using a CAD program or another suitable design program.

The processor 204 may fetch, decode, and execute the instructions 106 to, for a digital pore 212 of the digital pores 212, determine a distance between the digital pore 212 and a digital hole 220 of the plurality of digital holes 220 when the digital model 206 of the screen 208 is positioned on the digital model 214 of the mold body 216. That is, for instance, the processor 204 may position the screen digital model 206 on the mold body digital model 214 such that the positions of the digital models 206 and 214 correspond to positions in which the screen 208 and the mold body 216 may be positioned during their use in the formation of a wet part 302.

With reference to FIG. 2B, there is shown an enlarged view of a section of the example screen digital model 206 and the example main body digital model 214 positioned with respect to each other. Particularly, the enlarged view shows a digital hole 220 and multiple digital pores 212. As shown in that figure, the digital hole 220 in the main body digital model 214 may be significantly larger than the digital pores 212 in the screen digital model 206. In addition, some of the digital pores 212a and 212b may be aligned with the digital hole 220 while others of the digital pores 212c may be outside of the digital hole 220. The digital screen model 206, as well as the pore 210, may include pillars 250 that may contact a surface of the main body digital model 214 such that channels 252 through which a liquid and/or air may flow may be formed. The flow of the liquid and/or air is represented by arrows 234.

According to examples, the processor 204 may determine a distance between a digital pore 212a and the digital hole 220 that is the closest to the digital pore 212a. The distance may be the Euclidian distance between the digital pore 212a and the digital hole 220. In some examples, the processor 204 may determine the distance as the distance between the centers of the digital pore 212a and the digital hole 220. In other examples, the processor 204 may determine the distance as a distance between edges of the digital pore 212a and the digital hole 220. The edges may be the edges that are the closest to each other or the edges that are the furthest apart from each other or other portions of the digital pore 212a and the digital hole 220.

In some examples, the processor 204 may determine an effective distance between the digital pore 212a and a plurality of digital holes 220. The plurality of digital holes 220 may include the digital holes 220 in the main body digital model 214 that have a predefined level of influence over the digital pore 212a. In other words, the plurality of digital holes 220 may be the digital holes 220 from which or to which the digital pore 212a is determined to receive or send at least a predefined volume of liquid during use. In other examples, the plurality of digital holes 220 may be the digital holes 220 that are within a predefined distance from the digital pore 212a. The predefined level of influence and/or the predefined distance may be user-defined and/or may be determined through testing, modeling, and/or the like.

According to examples, the effective distance may include a sum of contributions of each of a number of the plurality of digital holes 220 to the digital pore 212a. That is, for instance, the processor 204 may, for the digital pore 212a, search in an area of up to a certain maximum distance around the digital pore 212a for the plurality of digital holes 220 within the search area. Then, for each of the plurality of digital holes 220 within the search area, the processor 204 may determine the contributions of the digital hole 220 to the digital pore 212a based on the distances of the digital hole to the digital pore 212a. For instance, the processor 204 may apply the following equation to determine the effective distance (D_{eff}) of the digital pore 212a from the plurality of digital holes 220 within the search area:

D_{eff}=(ΣkDᵢ^{p})⁻¹ Equation 1:

In Equation 1, Dᵢ may be a distance under consideration, k may represent a weighting factor, and p may represent a power factor, which may typically be a negative value. The weighting factor k and the power factor p may be determined through historical data determined through testing. In other examples, the weighting factor k and the power factor p may be determined through modeling and/or simulations. In other examples, a user may set the weighting factor k and the power factor p. As may be seen from Equation 1, the contribution levels of the digital holes 220 to the digital pore 212a may depreciate exponentially with respect to their distances from the digital pore 212a.

In some examples, the processor 204 may calculate the effective distance for the digital pore 212a through, for instance, application of Equation 1 or another suitable function. In other examples, a lookup table may be created to include the distances D between the digital pore 212a and a plurality of the digital pores 212 within a maximum distance from the digital pore 212a. In these examples, the processor 204 may approximate the effective distance for the digital pore 212a from the distances listed in the lookup table. For instance, the processor 204 may sum the contributions of each of the plurality of digital holes 220 within the maximum distance to the digital pore 212a by a lookup of the distances of those digital holes 220 to the digital pore 212a.

The processor 204 may fetch, decode, and execute the instructions 108 to, for the digital pore 212a of the digital pores 212, determine whether the determined distance falls below a first threshold. As discussed herein, the determined distance may be determined as a Euclidean distance between the digital pore 212a and a nearest digital pore 212. Alternatively, or additionally, the determined distance may be determined to be an effective distance for the digital pore 212a.

The processor 204 may fetch, decode, and execute the instructions 110 to, for the digital pore 212a of the digital pores 212, based on a determination that the determined distance falls below the first threshold, cause a parameter of the digital pore 212a to be modified in a first manner. Thus, for instance, the processor 204 may modify a parameter of the digital pore 212a when the distance between the digital pore 212a and a digital hole 220 (or the effective distance for the digital pore 212a) falls below the first threshold, the processor 204 may modify a parameter of the digital pore 212a in the first manner. The parameter of the digital pore 212a may be, for instance, a dimension of the digital pore 212a, such as a width of the digital pore. The parameter of the digital pore 212a may additionally or alternatively be a shape of the digital pore 212a.

By way of particular example, the processor 204 may cause the parameter of the digital pore 212a to be modified in the first manner by causing the digital pore 212a to be closed. In other examples, the processor 204 may cause the parameter to be modified by causing a dimension and/or shape of the digital pore 212a to be modified. The dimension may be modified by decreasing a width of the digital pore 212a. In some examples, the processor 204 may decrease the width and/or modify the shape based on a distance between the digital pore 212a and a nearest digital hole 220. For instance, the processor 204 may decrease the width to a greater extent when the digital pore 212a is closer to the nearest digital hole 220. Similarly, the processor 204 may modify the shape of the digital pore 212a, for instance, to have decreasing area, e.g., by changing from a 12-sided polygon down to a triangle, based on the distance.

In any of the instances discussed above, the first threshold may be a first distance threshold that may be determined through testing, modeling, simulation, final results, etc. The first threshold may also or alternatively be based on the materials included in a slurry upon which the screen 208 is to be in contact to form a wet part 302, a viscosity of the slurry, the thickness of a mold body 216, upon which the screen 208 is to be mounted, the thickness of the screen 208, the widths of the pores 210 in the screen 208, the widths of the holes 218 in the mold body 216, the positive and/or negative pressures to be applied during formation of a wet part 302, and/or the like.

According to examples, the processor 204 may make similar types of determinations for additional ones of the digital pores 212, e.g., for each of the other ones of the digital pores 212. That is, for instance, the processor 204 may determine a distance between another digital pore 212b and a digital hole 220 or multiple digital holes 220 and may determine whether the distance falls below the first threshold. The processor 204 may also determine whether the determined distance falls below the first threshold and may cause a parameter of the other digital pore 212b to be modified based on a determination that the determined distance falls below the first threshold.

According to examples, the processor 204 may determine whether the determined distance between the digital pore 212a and the digital hole 220 exceeds a second threshold in instances in which the determined distance exceeds the first threshold. Examples of the first threshold 240 and the second threshold 242 are depicted in FIG. 2C as extending from a center of the digital hole 220. As shown, the second threshold 242 may be relatively larger than the first threshold 240. In these examples, the second threshold 242 may be determined in similar manners to those discussed above with respect to the first threshold 240.

In some examples, the processor 204 may determine that the determined distance between the digital pore 212b exceeds the first threshold 240. Based on this determination, the processor 204 may determine whether the determined distance falls below the second threshold 242. In instances in which the determined distance exceeds the second threshold 242, the processor 204 may maintain the digital pore 212b as is. However, based on a determination that the determined distance falls below the second threshold 242, the processor 204 may cause the parameter of the digital pore 212b to be modified in a second manner. The second manner may be a modification that differs from the first manner, for instance, in magnitude and/or in type. For instance, the second manner may be a similar type of modification to the first manner, but may be a relatively smaller modification than the first manner.

By way of example, and as shown in FIG. 2C, the digital pore 212b may be modified to have a smaller width whereas the digital pore 212a, which is within the first threshold 240, may have been modified to be closed. As another example, the digital pore 212a may be modified to have a first shape and the digital pore 212b may be modified to have a second shape, in which the second shape may enable greater liquid and/or air flow than the first shape. In some examples, the processor 204 may determine an amount by which the determined distance falls below the second threshold 242, and equivalently, exceeds the first threshold 240. In these examples, the processor 204 may cause the parameter of the digital pore 212b to be modified in the second manner at a level corresponding to the determined amount. The correlation between the amount by which the determined distance falls below the second threshold 242 and the level to which the parameter of the digital pore 212b is modified in the second manner may be based on a function, stored in a lookup table, and/or the like. The levels of modification may be linearly related to the determined amount, or may be related in other ways, e.g., via some other function such as gradually, exponentially, or the like.

According to examples, the first threshold 240 and/or the second threshold 242 may be set such that the pores 210 corresponding to the digital pores 212 may have parameters that may result in the liquid and/or air to flow through the pores 210 in a substantially even manner. That is, the parameters of the digital pores 212 may be modified in manners that may prevent the formation of areas on the screen 208 at which liquid and/or air may flow at a rate beyond a predetermined rate with respect to other areas. The predetermined rate may be a rate that is likely to cause a wet part 302 to be damaged while the wet part 302 is being transferred from a forming tool 300 by a transfer tool 320 or from the transfer tool 320 as discussed in greater detail herein.

In instances in which the digital pore 212a is (or multiple digital pores 212 are) modified, the processor 204 may store the modification(s) as part of the screen digital model 206. That is, the processor 204 may modify the screen digital model 206 to include data identifying the modified digital pores 212. In these examples, the processor 204 may communicate the modified screen digital model 206 with the modified digital pores 212 to the 3D fabrication system 230. The 3D fabrication system 230 may use the modified screen digital model 206 to fabricate the screen 208 with pores 210 corresponding to the modified digital pores 212.

Alternatively, the processor 204 may store the modification(s) as a separate modified digital pore file 222. In these examples, the processor 204 may communicate the modified digital pore file 222 to the 3D fabrication system 230 such that the 3D fabrication system 230 may use the modified digital pore file 222 to determine which digital pores 212 in the screen digital model 206 may be modified prior to fabrication of the screen 208 from the screen digital model 206. According to examples, the modified digital pore file 222 may be a lookup table that identifies which of the digital pores 212 have been modified.

In any of these examples, the processor 204 may control fabrication components (not shown) of the 3D fabrication system 230 to fabricate the screen 208 to have pores 210 corresponding to the digital pores 212 and/or the modified digital pores 212. The processor 204 may, in some examples, be a processor 204 of an apparatus 202 that is external to the 3D fabrication system 230, while in other examples, the processor 204 may be part of the 3D fabrication system 230.

The 3D fabrication system 230 may be any suitable type of additive manufacturing system. Examples of suitable additive manufacturing systems may include systems that may employ curable binder jetting onto build materials (e.g., thermally or UV curable binders), print fluid jetting onto build materials (e.g., fusing, detailing agents), selective laser sintering, stereolithography, fused deposition modeling, etc. In a particular example, the 3D fabrication system 230 may form the screen 208 by binding and/or fusing build material particles together. In any of these examples, the build material particles may be any suitable type of material that may be employed in 3D fabrication processes, such as, a metal, a plastic, a nylon, a ceramic, an alloy, and/or the like. Generally speaking, higher functionality/performance screens 206 may be those with the smallest pore size to block fibers of smaller sizes, and hence some 3D fabrication system technologies may be more suited for generating the screens 208 than others.

In some examples, the processor 204 may be part of an apparatus 202, which may be a computing system such as a server, a laptop computer, a tablet computer, a desktop computer, or the like. The processor 204 may be a semiconductor-based microprocessor, a central processing unit (CPU), an application specific integrated circuit (ASIC), a field-programmable gate array (FPGA), and/or other suitable hardware device. The apparatus 202 may also include a memory 224 that may have stored thereon computer-readable instructions (which may also be termed computer-readable instructions) that the processor 204 may execute, such as the computer-readable medium 100 depicted in FIG. 1.

By way of example, the apparatus 202 may include a memory 224 on which is stored instructions that when executed by the processor 204, may cause the processor 204 to obtain a digital model 206 of a transfer screen 324, in which the digital model 206 of the transfer screen 324 may include a plurality of digital pores 212. The instructions may also cause the processor 204 to obtain a digital model 214 of a transfer mold body 322 on which the transfer screen 324 is to be mounted. The digital model 214 of the transfer mold body 322 may include a plurality of digital holes 220, in which the transfer screen 324 and the transfer mold body 322 are to be used during a fabrication process of a wet part 302 from a slurry of liquid and material elements. The instructions may further cause the processor 204 to determine a distance between a digital pore 212 of the plurality of digital pores and a digital hole 220 of the plurality of digital holes 220 when the digital model 206 of the transfer screen 324 is positioned on the digital model 214 of the transfer mold body 322. The instructions may still further cause the processor 204 to determine whether the determined distance falls below a first threshold 240 and based on a determination that the determined distance falls below the first threshold 240, cause a size and/or a shape of the digital pore 212 to be modified in a first manner.

As shown in FIG. 3A, the screen 208 may be a forming screen 308 of a forming tool 300, which may be implemented in a formation of a wet part 302 from a slurry 304 of a liquid and material elements. In other examples, and as shown in FIG. 3B, the screen 208 may be a transfer screen 324 of a transfer tool 320. FIG. 3A shows a cross-sectional side view of a forming tool 300, in which a portion of the forming tool 300 has been depicted as being placed within a volume of the slurry 304. FIG. 3B shows a cross-sectional side view of the transfer tool 320 that may remove the wet part 302 from the forming screen 308. The forming tool 300 and the transfer tool 320 may collectively form a pulp molding tool set.

As shown in FIG. 3A, the forming tool 300 may include a forming mold 306 and a forming screen 308, in which the forming screen 308 may overlay the forming mold 306. As shown in FIG. 3B, the transfer tool 320 may include a transfer mold body 322 and a transfer screen 324. In some examples, the 3D fabrication system 230 may fabricate any or all of the forming screen 308, the transfer screen 324, the forming mold 306, and the transfer screen 324 using the screen digital model 206 and/or the mold body digital model 214. The forming screen 308 and the transfer screen 324 may be used to form wet parts 302, e.g., molded fiber articles.

In some examples, the forming mold 306 and/or the transfer mold body 322 may be removably mounted onto respective supporting structures (not shown) such that, for instance, the forming mold 306 may be moved independently from the transfer mold body 322. Moreover, the forming mold 306 and the forming screen 308 may be fabricated to have shapes to which the wet part 302 may be molded when formed on the forming screen 308. Likewise, the transfer mold body 322 and the transfer screen 324 may be fabricated to have shapes that may engage multiple surfaces of the wet part 302 formed on the forming screen 308. The transfer screen 324 may have a shape that is complementary to the shape of the forming screen 308.

As shown, the forming mold 306 may be formed to have a relatively larger thickness than the forming screen 308 and the transfer mold body 322 may be formed to have a relatively larger thickness than the transfer screen 324. In some examples, the transfer screen 324 and the forming screen 308 may have the same or similar thicknesses and/or the transfer mold body 322 and the forming mold 306 may have the same or similar thicknesses. The larger thicknesses of the forming mold 306 and the transfer mold body 322 may cause the forming mold 306 and the transfer mold body 322 to be substantially more rigid than the forming screen 308 and the transfer screen 324. The forming mold 306 may provide structural support for the forming screen 308 and the transfer mold body 322 may provide structural support for the transfer screen 324. By way of particular non-limiting example, the transfer screen 324 and the forming screen 308 may have thicknesses in the range of about 1 mm and 2 mm and the transfer mold body 322 and the forming mold 306 may have thicknesses in the range of about 5-8 mm.

Although not shown, the forming tool 300 may be in communication with a plenum to which a vacuum source may be connected such that the vacuum source may apply a vacuum pressure through holes 310 in the forming mold 306 and pores 312 in the forming screen 308. When the vacuum pressure is applied through the holes 310 and pores 312, some of the liquid in the slurry 304 may be suctioned through the holes 310 and the pores 312 and may flow into the plenum as denoted by the arrows 314. As the liquid flows through the holes 310 and the pores 312, the forming screen 308 may prevent the material elements in the slurry 304 from flowing through the pores 312. That is, the pores 312 may have sufficiently small dimensions, e.g., diameters or widths, that may enable the liquid to flow through the pores 312 while blocking the material elements from flowing through the pores 312. In one regard, the diameters or widths of the pores 312 may be sized based on sizes of the material elements, e.g., fibers, in the slurry 304. By way of particular non-limiting example, the pores 312 may have diameters of around 0.6 mm and the holes 310 may have diameters of around 5 mm. However, in some instances, the pores 312 may have irregular shapes as may occur during 3D fabrication processes.

Over a period of time, which may be a relatively short period of time, e.g., about a few seconds, less than about a minute, less than about five minutes, or the like, the material elements may build up on the forming screen 308. Particularly, the material elements in the slurry 304 may be accumulated and compressed onto the forming screen 308 into the wet part 302. The wet part 302 may take the shape of the forming screen 308. In addition, the thickness and density of the wet part 302 may be affected by the types and/or sizes of the material elements in the slurry 304, the length of time that the vacuum pressure is applied while the forming mold 306 and the forming screen 308 are placed within the volume of the slurry 304, etc. That is, for instance, the longer that the vacuum pressure is applied while the forming mold 306 and the forming screen 308 are partially immersed in the slurry 304, the wet part 302 may be formed to have a greater thickness.

After a predefined period of time, e.g., after the wet part 302 having desired properties has been formed on the forming screen 308, the forming mold 306 and the forming screen 308 may be removed from the volume of slurry 304. For instance, the forming mold 306 may be mounted to a movable mechanism that may move away from the volume of slurry 304. In some examples, the movable mechanism may rotate with respect to the volume such that rotation of the movable mechanism may cause the forming mold 306 and the forming screen 308 to be removed from the volume of slurry 304. In other examples, the movable mechanism may be moved laterally with respect to the volume of slurry 304. As the forming mold 306 and the forming screen 308 are removed from the volume, some of the excess slurry 304 may come off of the wet part 302. However, the wet part 302 may have a relatively high concentration of liquid.

Following the formation of the wet part 302 on the forming screen 308 and movement of the forming screen 308 and the wet part 302 out of the volume of slurry 304, the transfer tool 320 may be moved such that the transfer screen 324 may contact the wet part 302 on the forming screen 308. That is, for instance, the transfer mold body 322 may be attached to a movable mechanism (not shown), in which the movable mechanism may cause the transfer mold 306 and the transfer screen 324 to move toward the forming screen 308. In some examples, the transfer tool 320 may be moved to cause the transfer screen 324 to be in contact with the wet part 302 prior to the wet part 302 being de-watered while on the forming screen 308, e.g., within a few seconds of the wet part 302 being removed from the volume of slurry 304. In one regard, the transfer tool 320 may engage the wet part 302 relatively quickly after formation of the wet part 302, which may enable the transfer tool 320 to remove the wet part 302 relatively quickly and the forming tool 300 to be inserted into the volume of slurry 304 to form a next wet part 302.

In addition, the transfer tool 320 may be in communication with a plenum to which a vacuum source may connected such that the vacuum source may apply a vacuum pressure through holes 326 in the transfer mold body 322 and pores 328 in the transfer screen 324 while the wet part 302 is in contact with the transfer screen 324. The vacuum source may be the same or a different vacuum source to which the forming tool 300 may be in communication. The vacuum pressure applied through the forming tool 300 may be terminated or reversed (e.g., applied in the opposite direction) while the vacuum pressure is applied through the transfer tool 320. In addition, airflow may be supplied through the holes 326 and the transfer screen 324 to blow the wet part 302 off of the transfer screen 324.

Generally speaking, liquid and/or airflow may not be supplied evenly across the transfer screen 324 during the removal of the wet part 302 from the forming screen 308 and/or from the transfer screen 324. For instance, air may flow at a greater volumetric rate through the pores 328 that are directly over a hole 326 than the pores 328 that are not directly over a hole 326. In some instances in which the volumetric flow rate difference across some of the pores 328 are sufficiently high, a blow-out condition may occur, which may cause damage to the wet part 302. As discussed herein, the parameters of some of the pores 328 may be modified depending upon their distances from the holes 326. In one regard, the parameters may be modified to reduce the differences in volumetric flow rates through the pores 328 across the transfer screen 324 and thus reduce or eliminate damage caused to the wet part 302.

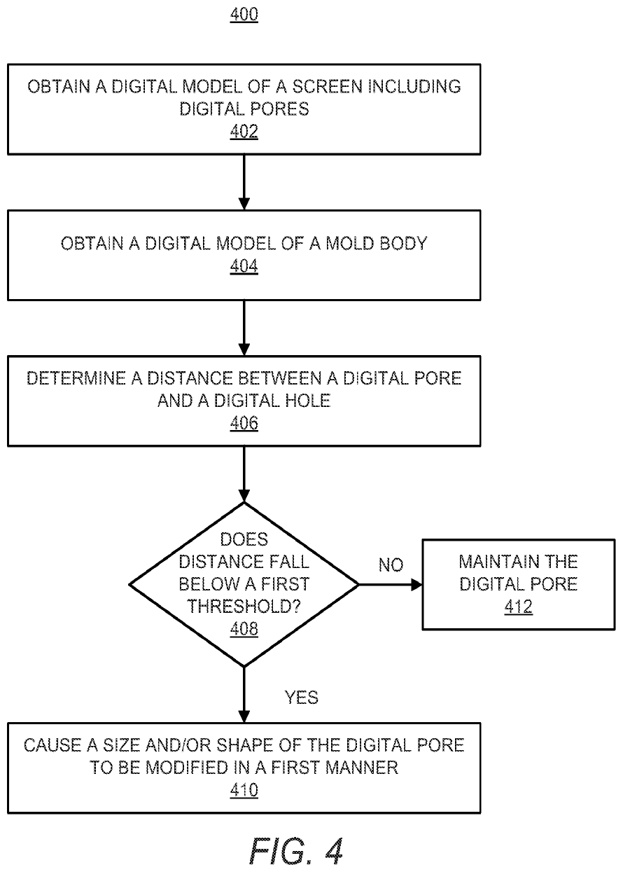

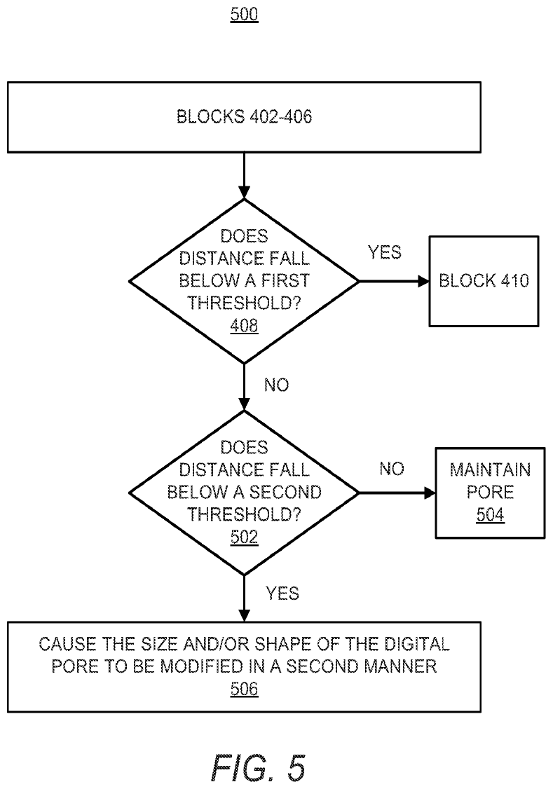

Turning now to FIGS. 4 and 5, there are respectively shown flow diagrams of example methods 400, 500 for causing a size and/or a shape of a digital pore 212 to be modified based on a distance between the digital pore 212 and a digital hole 220 in a mold body digital model 214. It should be understood that the methods 400 and 500 respectively depicted in FIGS. 4 and 5 may include additional operations and that some of the operations described therein may be removed and/or modified without departing from the scopes of the methods 400 and 500. The descriptions of the methods 400 and 500 are also made with reference to the features depicted in FIGS. 1-3B for purposes of illustration. Particularly, the processor 204 depicted in FIG. 2 may execute some or all of the operations included in the methods 400 and 500.

With reference first to FIG. 4, at block 402, the processor 204 may obtain a digital model 206 of a screen 208 to be fabricated by a 3D fabrication system, in which the digital model 206 may include a plurality of digital pores 212. At block 404, the processor 204 obtain a digital model 214 of a mold body 216, in which the digital model 214 may include a plurality of digital holes 220. At block 406, the processor 204 may determine a distance between a digital pore 212 of the plurality of digital pores 212 and a digital hole 220 of the plurality of digital holes 220 when the screen digital model 206 is positioned on the mold body digital model 214. At block 408, the processor 204 may determine whether the determined distance falls below a first threshold 240. In addition, based on a determination that the determined distance falls below the first threshold 240, at block 410, the processor 204 may cause a size and/or a shape of the digital pore 212 to be modified in a first manner. However, based on a determination that the determined distance exceeds the first threshold 240, at block 412, the processor 204 may maintain the size and shape of the digital pore 212.

As discussed herein, the processor 204 may modify the screen digital model 206 to incorporate the modified digital pore 212. Additionally, or alternatively, the processor 204 may generate a modified digital pore file 222 that identifies the modification to the digital pore 212.

With reference now to FIG. 5, the processor 204 may execute blocks 402-410, which have been described with respect to FIG. 4. That is, based on a determination that the determined distance between the digital pore 212 and the digital hole 220 falls below the first threshold, the processor 204 may cause a size and/or a shape of the digital pore 212 to be modified in a first manner.

However, based on a determination that the determined distance does not fall below the first threshold, e.g., that the determined distance exceeds the first threshold, at block 502, the processor 204 may determine whether the determined distance falls below a second threshold 242. Based on a determination that the determined distance exceeds the second threshold 242, at block 504, the processor 204 may maintain the size and shape of the digital pore 212. However, based on a determination that the determined distance falls below the second threshold 242, at block 506, the processor 204 may cause the size and/or the shape of the digital pore 212 to be modified in a second manner. In some examples, and as discussed herein, the processor 204 may determine an amount by which the determined distance falls below the second threshold 242. In addition, the processor 204 may cause the size and/or shape of the digital pore 212 to be modified in the second manner at a level corresponding to the determined amount.

Some or all of the operations set forth in the methods 400 and 500 may be contained as utilities, programs, or subprograms, in any desired computer accessible medium. In addition, the methods 400 and 500 may be embodied by computer programs, which may exist in a variety of forms. For example, the methods 400 and 500 may exist as computer-readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A non-transitory computer-readable medium on which is stored computer-readable instructions that when executed by a processor, cause the processor to:
obtain a digital model of a screen to be fabricated by a three-dimensional (3D) fabrication system, the digital model of the screen including a plurality of digital pores;
obtain a digital model of a mold body on which the screen is to be removably mounted, the digital model of the mold body including a plurality of digital holes; and
for a digital pore of the plurality of digital pores,
determine a distance between the digital pore and a digital hole of the plurality of digital holes when the digital model of the screen is positioned on the digital model of the mold body;
determine whether the determined distance falls below a first threshold; and
based on a determination that the determined distance falls below the first threshold, cause a parameter of the digital pore to be modified in a first manner.

2. The non-transitory computer-readable medium of claim 1, wherein to cause the parameter of the digital pore to be modified in the first manner, the instructions are further to cause the processor to:
cause the digital pore to be closed.

3. The non-transitory computer-readable medium of claim 1, wherein to cause the parameter of the digital pore to be modified in the first manner, the instructions are further to cause the processor to:
cause a dimension and/or a shape of the digital pore to be modified in the first manner.

4. The non-transitory computer-readable medium of claim 1, wherein the instructions are further to cause the processor to:
determine that the determined distance exceeds the first threshold;
based on the determined distance exceeding the first threshold, determine whether the determined distance falls below a second threshold, wherein the second threshold is greater than the first threshold; and
based on a determination that the determined distance falls below the second threshold, cause the parameter of the digital pore to be modified in a second manner.

5. The non-transitory computer-readable medium of claim 4, wherein the instructions are further to cause the processor to:
based on a determination that the determined distance meets or exceeds the second threshold, maintain the parameter of the digital pore.

6. The non-transitory computer-readable medium of claim 4, wherein to cause the parameter of the digital pore to be modified in the second manner, the instructions are further to cause the processor to:
cause a dimension and/or a shape of the digital pore to be modified in the second manner.

7. The non-transitory computer-readable medium of claim 4, wherein the instructions are further to cause the processor to:
determine an amount by which the determined distance falls below the second threshold; and
cause the parameter of the digital pore to be modified in the second manner at a level corresponding to the determined amount.

8. The non-transitory computer-readable medium of claim 1, wherein to determine the distance, the instructions are further to cause the processor to:
determine an effective distance between the digital pore and the plurality of digital holes, wherein the effective distance includes a sum of contributions of each of a number of the plurality digital holes to the digital pore.

9. The non-transitory computer-readable medium of claim 1, wherein the instructions are further to cause the processor to:
control fabrication components of the 3D fabrication system to fabricate the screen to include the digital pore having the modified parameter.

10. A method comprising:
obtaining, by a processor, a digital model of a screen to be fabricated by a three-dimensional (3D) fabrication system, the digital model of the screen including a plurality of digital pores;
obtaining, by the processor, a digital model of a mold body on which the screen is to be mounted, the digital model of the mold body including a plurality of digital holes;
determining, by the processor, a distance between a digital pore of the plurality of digital pores and a digital hole of the plurality of digital holes when the digital model of the screen is positioned on the digital model of the mold body;
determining, by the processor, whether the determined distance falls below a first threshold; and
based on a determination that the determined distance falls below the first threshold, causing, by the processor, a size and/or a shape of the digital pore to be modified in a first manner.

11. The method of claim 10, further comprising:
determining a level to which the size and/or the shape of the digital pore is to be modified based on an amount that the determined distance falls below the first threshold.

12. The method of claim 10, further comprising:
based on a determination that the determined distance exceeds the first threshold, determining whether the determined distance falls below a second threshold, wherein the second threshold is greater than the first threshold; and
based on a determination that the determined distance falls below the second threshold, causing the size and/or the shape of the digital pore to be modified in a second manner.

13. The method of claim 12, further comprising:
determining an amount by which the determined distance falls below the second threshold; and
causing the size and/or shape of the digital pore to be modified in the second manner at a level corresponding to the determined amount.

14. An apparatus comprising:
a processor; and
a memory on which is stored instructions that when executed by the processor, cause the processor to:
obtain a digital model of a transfer screen, the digital model of the transfer screen having a plurality of digital pores;
obtain a digital model of a transfer mold body on which the transfer screen is to be mounted, the digital model of the transfer mold body including a plurality of digital holes, wherein the transfer screen and the transfer mold are to be used in a fabrication process of a part from a slurry of liquid and material elements;
determine a distance between a digital pore of the plurality of digital pores and a digital hole of the plurality of digital holes when the digital model of the transfer screen is positioned on the digital model of the transfer mold body;
determine whether the determined distance falls below a first threshold; and
based on a determination that the determined distance falls below the first threshold, cause a size and/or a shape of the digital pore to be modified in a first manner.

15. The apparatus of claim 14, wherein the instructions are further to cause the processor to:
based on a determination that the determined distance exceeds the first threshold, determine whether the determined distance falls below a second threshold, wherein the second threshold is greater than the first threshold; and
based on a determination that the determined distance falls below the second threshold, cause the size and/or the shape of the digital pore to be modified in a second manner.
